(19) United States
(12) Patent Application Publication
(10) Pub. No.: US 2007/0084109 A1
(43) Pub. Date: Apr. 19, 2007

(54) Plant pot with irrigation control

(76) Inventor: Clinton W. Brister, Boyce, LA (US)

Correspondence Address: SUNG I. OH, PROFESSIONAL LAW CORPORATION, 710 QUAIL VALLEY LANE, WEST COVINA, CA, 91791, US

(21) Appl. No.: 11/254,258

(22) Filed: Oct. 19, 2005

(51) Int. Cl. A01G 29/00

(52) U.S. Cl. 47/48.5

(57) ABSTRACT

A plant pot includes a drainage hose having a first end thereof fluidically connected to the bottom of the pot. The hose is flexible and has a minimum length that is equal to the height of the pot. The hose is clamped to the top of the pot during a watering process so a second end of the hose is at, or above the top surface level of the soil in the pot. After the plant has been watered, the hose is released so the second end is released and is allowed to fall beneath the level of the bottom of the soil in the pot.

### 1. FIELD OF THE INVENTION

The present invention relates to the general art of plant husbandry, and to the particular field of irrigating growing receptacles.

### 2. BACKGROUND OF THE INVENTION

Plant pots come in a variety of sizes and shapes but typically have a hole or drainage portal in the bottom to allow for gravitational drainage of water, which may contain fertilizer, plant food or the like. While the drainage hole is designed to allow fluid to escape the pot, such a passive system creates several problems. Often the pot is standing on a saucer-like plate having an upstanding rim to catch and contain the water. The problem is that the drainage water stands in the plate until it evaporates, is pulled back in by capillary action, is manually removed or recycled into the topsoil of the plant. Sometimes, the water spills over the plate and falls onto furniture or other items located near the pot, which is, of course, undesirable.

Manual removal of the water sometimes does not occur as often as is desirable for any number of reasons, e.g. the plant owner may be absent for an extended period, may simply forget or the pot may be heavy or difficult to lift. The drainage water may therefore be left standing for a long period of time, which causes root rot, and is hygienically and esthetically undesirable. It will also be appreciated that standing water is generally detrimental for the floor, deck or other supporting surface.

Manual removal itself creates problems, since spillage sometimes occurs. Also the standing water can overflow the saucer if not removed for an extended period. Further, it is evident that a system which eliminates the necessity for manual removal of water would be inherently desirable by reducing plant maintenance. What is needed is a plant drainage system which allows for drainage of water from the bottom of the plant so as to eliminate the water without the necessity of manual removal and to prevent the build up of standing water in undesirable areas.

While various attempts have been made at maintaining proper water concentrations in potted plants, such as locating the water supply a distance from the pot, using pumps, valves and the like, as well as wicks, these attempts have disadvantages such as inadequate regulation of the amount of moisture in the soil, and a requirement for electronic or mechanical equipment.

Therefore, there is a need for a system for maintaining a desired amount of moisture in the soil of a potted plant in a simple and inexpensive manner that does not have the drawbacks discussed above in relation to a drainage hole in center of the bottom of the pot.

### INVENTION SUMMARY

These, and other, objects are achieved by a plant pot that includes a drainage hose having a first end thereof fluidically connected to the bottom of the pot. The hose is flexible and has a minimum length that is equal to the height of the pot. The hose is clamped to the top of the pot during a watering process so a second end of the hose is at, or above the top surface level of the soil in the pot. After the plant has been watered, the hose is released so the second end is released and is allowed to fall beneath the level of the bottom of the soil in the pot.

Water level in the pot is controlled by the hose having the second end initially located at or above the top level of the soil in the pot and then below the bottom level of the soil in the pot so water is properly placed in the pot and then properly drains out of the pot without the need of a hole in the bottom of the pot or without the need of valves, mechanical or electrical equipment or wicks.

Other systems, methods, features, and advantages of the invention will be, or will become, apparent to one with skill in the art upon examination of the following figures and detailed description. It is intended that all such additional systems, methods, features, and advantages be included within this description, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a perspective view of a plant pot embodying the present invention.

FIG. 2 is an elevational view taken along line 2-2 of FIG. 1.

### DETAILED DESCRIPTION OF THE INVENTION

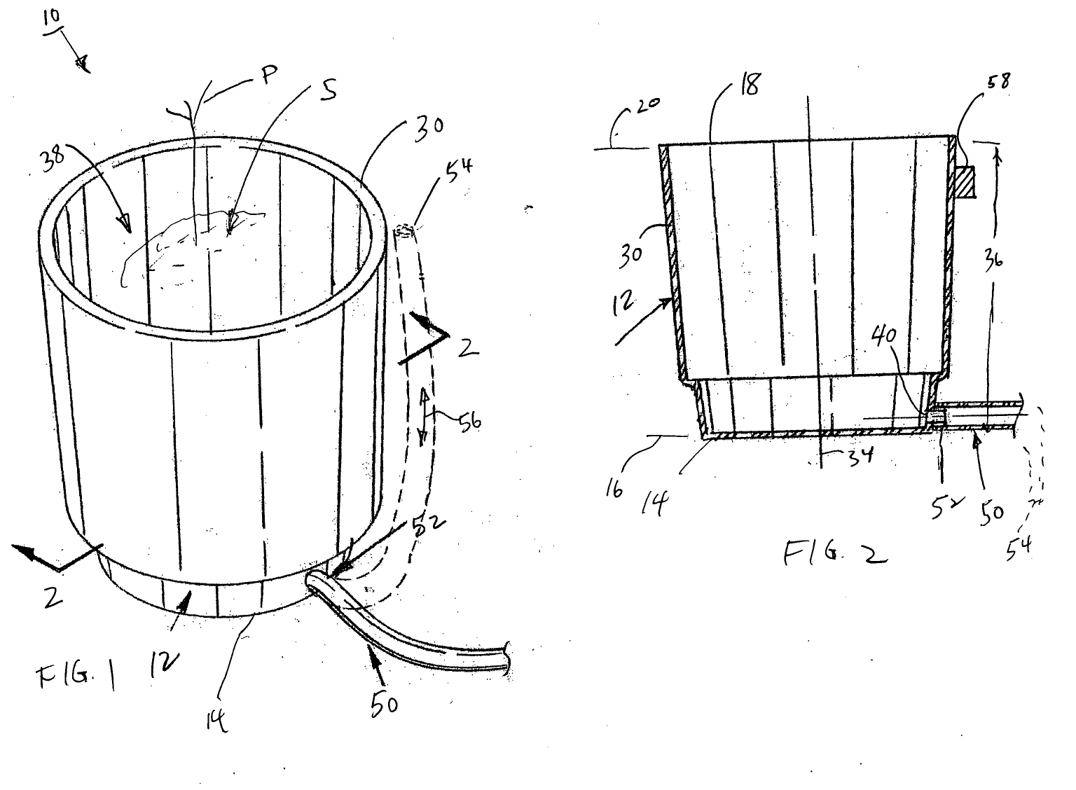

FIG. 1 shows a plant pot 10 having a shell 12 which has a first end 14 which is a bottom end when shell 12 is in use as shown in the figures. First end 14 is contained in a first plane 16 which is generally horizontal when pot 10 is in use. Shell 12 further includes a second end 18 which is a top end when shell 12 is in use. Second end 18 is contained in a second plane 20 located vertically above first plane 16 and which is generally horizontal when shell 12 is in use.

A tubular wall 30 connects first end 14 to second end 18 and has an outer dimension 32 which is larger adjacent to second end 18 than adjacent to first end 14. Wall 30 has a central longitudinal axis 34. Wall 30 has a height dimension 36 which is measured along longitudinal axis 34 of the tubular wall between first end 14 and second end 18. An interior volume 38 is defined by first end 14 and wall 30 and is adapted to contain soil S in which a plant P can grow. An outlet port 40 is defined in wall 30 adjacent to first end 14. Outlet port is spaced apart from longitudinal axis 34 of the tubular wall and is oriented to be upright with respect to first plane 16.

A flexible hose 50, which can be plastic or the like, has a first end 52 fluidically connected to outlet port 40, a second end 54 and a length dimension 56 which extends between first end 52 of the flexible hose and second end 54 of the flexible hose. Length dimension 56 of flexible hose 50 is at least equal to height dimension 36 of shell 12. Thus, hose 50 has a minimum length at least equal to the height dimension of the shell.

Flexible 50 is movable between a fill orientation shown in dotted lines in FIG. 1 with second end 54 located adjacent to second end 18 of shell 12 and a drain orientation shown in solid lines in FIG. 1 with second end 54 located beneath first plane 16 whereby second end 54 of the flexible hose is located above first end 52 of the flexible hose and above outlet port 40 when flexible hose 50 is in the fill orientation and second end 54 of the flexible hose is located below first plane 16 when the flexible hose is in the drain orientation so that liquid placed in the soil contained in the shell with the flexible hose in the fill orientation will not flow out of the second end of the flexible hose and liquid in the soil in the shell will drain out of the soil and out of the second end of the flexible hose when the flexible hose is in the drain orientation. Plant pot 10 may have a clip 58 so that the flexible hose can be clipped or otherwise attached to the top of the shell during the fill process. The upright orientation of outlet port 40 permits proper drainage of the liquid from the soil in the shell.

Use of plant pot 10 can be understood from the foregoing description and includes moving the flexible irrigation hose into an upright orientation with the second end of the flexible hose located adjacent to the upper end of the plant pot and above the first end of the flexible hose and above the fluidic coupling between the first end of the flexible hose and the interior of the plant pot which is established via port 40; placing liquid in the soil in the interior of the plant pot; moving the second end of the flexible hose beneath the first end of the flexible hose and beneath the fluidic coupling between the first end of the flexible hose and the interior of the plant pot; and permitting the liquid to drain out of the soil in the interior of the plant pot via the flexible hose. It is noted that liquid drained from the pot can be directed to a suitable reservoir and re-used if suitable.

While various embodiments of the invention have been described, it will be apparent to those of ordinary skill in the art that many more embodiments and implementations are possible within the scope of this invention. Accordingly, the invention is not to be restricted except in light of the attached claims and their equivalents.

1. A plant pot consisting of:
A) a shell having
(1) a first end which is a bottom end when said shell is in use, the first end being contained in a first plane,
(2) a second end which is a top end when said shell is in use, the second end being contained in a second plane, with the second plane being located vertically above the first plane when said shell is in use,
(3) a tubular wall connecting the first end to the second end, the tubular wall having an outer dimension and a central longitudinal axis,
(4) a height dimension which is measured along the longitudinal axis of the tubular wall between the first end and the second end, and
(5) an interior volume defined by the first end and the wall, the interior volume being adapted to contain soil in which a plant can grow and a plant in the soil;
B) an outlet port defined in the wall adjacent to the first end, said outlet port being spaced apart from the longitudinal axis of the tubular wall and is oriented to be upright with respect to the first plane;
C) a flexible hose having
(1) a first end fluidically connected to said outlet port,
(2) a second end, and
(3) a length dimension which extends between the first end of said flexible hose and the second end of said flexible hose, the length dimension of said flexible hose being at least equal to the height dimension of said shell, said flexible hose being movable between a fill orientation with the second end of said flexible hose being located adjacent to the second end of said shell and a drain orientation with the second end of said flexible hose being located beneath the first plane containing the first end of said shell whereby the second end of said flexible hose is located above the first end of said flexible hose and above said outlet port when said flexible hose is in the fill orientation and the second end of said flexible hose is located below the first plane when said flexible hose is in the drain orientation so that liquid placed in soil contained in said shell with said flexible hose in the fill orientation will not flow out of the second end of said flexible hose and liquid in the soil in said shell will drain out of the soil and out of the second end of said flexible hose when said flexible hose is in the drain orientation; and
D) a clip coupled to the second end of the shell, the clip adapted to hold the second end of the flexible hose adjacent to the second end of the shell.

2. The plant pot defined in claim 1 wherein the outer dimension of the wall of said shell is greater adjacent to the second end than the outer dimension of the wall adjacent to the first end.

3. The plant pot defined in claim 1 wherein said outlet port is located adjacent to the first end.

4. A plant pot comprising:
A) a shell having a fist end, a second end, a height dimension which extends between the first end and the second end, a tubular wall, a central longitudinal axis, the plant pot being adapted to contain potting soil and a plant in the potting soil;
B) a fluid outlet port defined in the tubular wall to be spaced apart from the longitudinal axis and to be oriented upright with respect to the first end of the shell, the fluid outlet port being located adjacent to the first end of the shell and being in fluid communication with potting soil located in the plant pot;
C) a flexible hose having
(1) a first end fluidically connected to said fluid outlet port, and
(2) a second end;
D) said flexible hose being movable between a fill orientation with the second end of said flexible hose located adjacent to the second end of the shell and a drain orientation with the second end of said flexible hose being located beneath the first end of the shell whereby the second end of said flexible hose is located above the first end of said flexible hose and above said fluid outlet port when said flexible hose is in the fill orientation and the second end of said flexible hose is located below the first end of the shell when said flexible hose is in the drain orientation so that liquid placed in soil contained in the plant pot with said flexible hose in the fill orientation will not flow out of the second end of said flexible hose and liquid in the soil in the plant pot will drain out of the soil and out of the second end of said flexible hose when said flexible hose is in the drain orientation; and
E) a clip coupled to the second end of the shell, the clip adapted to hold the second end of the flexible hose adjacent to the second end of the shell.

5. The plant pot according to claim 4, where the flexible hose has a length dimension measured between the first end of said flexible hose and the second end of said flexible hose, the length dimension of said flexible hose being at least equal to the height dimension of the plant pot.

6. The plant pot according to claim 4, including a clip, where the clip is attached to the shell to releasably hold said flexible hose is in the fill orientation.

7. A method of irrigating a potted plant consisting of:
A) providing a plant pot having a wall with a central axis, a lower end and an upper end and height dimension which extends between the lower end and the upper end, a fluid port defined in the wall and oriented to be upright with respect to the lower end of the pot and which is spaced apart from the central axis of the pot, a flexible irrigation hose that has one end thereof coupled to fluid port in the wall of the plant pot and fluidically coupled to the interior of the plant pot and a second end, the flexible hose having a length dimension measured between the first end of the flexible hose and the second end of the flexible hose that is at least equal to the height dimension of the plant pot, the plant pot containing potting soil and a plant in the potting soil;
B) moving the flexible irrigation hose into an upright orientation with the second end of the flexible hose located adjacent to the upper end of the plant pot and above the first end of the flexible hose and above the fluidic coupling between the first end of the flexible hose and the interior of the plant pot;
C) placing liquid in the soil in the interior of the plant pot;
D) moving the second end of the flexible hose beneath the first end of the flexible hose and beneath the fluidic coupling between the first end of the flexible hose and the interior of the plant pot;
E) permitting the liquid to drain out of the soil in the interior of the plant pot via the flexible hose; and
F) attaching the second end of the flexible irrigation hose to the upper end of the plant pot.
